(19) United States
(12) Patent Application Publication
(10) Pub. No.: US 2024/0098834 A1
(43) Pub. Date: Mar. 21, 2024

(54) METHOD FOR DISCONTINUOUS COMMUNICATION

(71) Applicant: ZTE Corporation, Shenzhen (CN)

(72) Inventors: Chenchen ZHANG, Shenzhen (CN); Nan ZHANG, Shenzhen (CN); Wei CAO, Shenzhen (CN); Jianqiang DAI, Shenzhen (CN); Kaibo TIAN, Shenzhen (CN)

(21) Appl. No.: 18/474,906

(22) Filed: Sep. 26, 2023

Related U.S. Application Data
(63) Continuation of application No. PCT/CN2021/085676, filed on Apr. 6, 2021.

(51) Int. Cl. H04W 76/27; H04W 76/28

(52) U.S. Cl. CPC H04W 76/27; H04W 76/28

(57) ABSTRACT

A wireless communication method for use in a wireless terminal is disclosed. The method comprises switching from a first state to a second state according to at least one time value.

### RELATED APPLICATION

This application is a continuation of International Patent Application No. PCT/CN2021/085676, filed Apr. 6, 2021 and entitled “A Method for Discontinuous Communication,” which is incorporated herein by reference in their entireties.

### RELATED ART

This document is directed generally to wireless communications, in particular to discontinuous communications.

In the narrow band internet-of-things (NB-IoT), a discontinuous wireless transmission may be triggered by techniques of saving power such as discontinuous reception (DRX), extended DRX (eDRX) and power saving mode (PSM). As shown in FIG. 1, an NB-IoT user equipment (UE) may enter a sleep mode or a deep sleep mode (i.e. standby mode) for saving power.

In long term evolution (LTE), the DRX cycles in the connected mode comprises a short DRX cycle and a long DRX cycle (see FIG. 2). The cycle of discontinuous transmissions of the DRX in the idle mode is longer than each of those of the DRX in the connected mode, which is also called paging cycle.

For a fixed UE, wireless signals from a non-terrestrial network may be variate, discontinuous and fluctuated in their signal strength, as shown in FIG. 3. Thus, the mechanisms associated with the DRX, the eDRX or the PSM may require to be accordingly changed, so as to be applied in various scenarios.

### SUMMARY

This document relates to methods, systems, and devices for the discontinuous communications.

The present disclosure relates to a wireless communication method for use in a wireless terminal. The method comprises switching from a first state to a second state according to at least one time value.

Various embodiments may preferably implement the following features:

Preferably, wherein the first state is one of an active state or an inactive state and the second state is another one of the active state or the inactive state.

Preferably, the active state is a radio resource control connected state or a state of performing communications according to a scheduling.

Preferably, the inactive state is a sleep state or a standby state.

Preferably, a first timer configured with a first time value in the at least one time value is started, wherein switching from the first state to the second state according to at least one time value comprises: switching to the second state when the first timer expires.

Preferably, the first timer is a power saving mode timer or an on-duration timer for discontinuous reception

Preferably, switching from the first state to the second state according to at least one time value comprises:
receiving a first number of DL channels, and
switching to the second state after a time offset after receiving the last DL channel,
wherein the time offset is configured as one of the at least one time value

Preferably, switching from the first state to the second state according to at least one time value comprises:
transmitting a second number of UL channels, and switching to the second state a time offset after transmitting the last UL channel,
wherein the time offset is one of the at least one time value.

Preferably, a second timer configured with at least one second time value in the at least one time value is started, wherein switching from the first state to the second state according to at least one time value comprises at least one of:
switching to the second state each time of an expiry of the second timer, or
monitoring a physical downlink control channel after the second timer expires. Preferably, the second timer is a tracking area update timer.

Preferably, a third timer is configured with a third time value in the at least one time value, wherein the third timer is triggered by a start of at least one hybrid automatic repeat request, HARQ, process and switching from the first state to the second state according to at least one time value comprises at least one of:
switching to the second state after finishing the at least one HARQ process, or
monitoring a physical downlink control channel after the third timer expires.

Preferably, the wireless communication method further comprises receiving, from a wireless network node, indication information, wherein switching from the first state to the second state according to at least one time value comprises at least one of:
performing, with the wireless network node, a UL synchronization within a fifth time value in the at least one time value after receiving the indication information, or
performing, with the wireless network node, a UL transmission a fifth time value in the at least one time value after receiving the indication information.

Preferably, the UL synchronization is at least one of: a global navigation satellite system reception, a tracking area calculation, or a frequency offset calculation.

Preferably, the fifth time value is an additional offset configured by a wireless network node.

Preferably, the wireless communication method further comprises transmitting, to a wireless network node, position information of the wireless terminal.

The present disclosure relates to a wireless communication method for use in a wireless network node. The method comprises:
transmitting, to a wireless terminal, at least one time value associated with switching the wireless terminal from a first state to a second state.

Various embodiments may preferably implement the following features:

Preferably, the first state is one of an active state or an inactive state and the second state is another one of the active state or the inactive state.

Preferably, the active state is a radio resource control connected state or a state of performing communications according to a scheduling.

Preferably, the inactive state is a sleep state or a standby state.

Preferably, the at least one time value comprises a first time value associated with a first timer, wherein the first timer configured with the first time value is configured to indicate the wireless terminal to switch to the second state after an expiry of the first timer.

Preferably, the first timer is a power saving mode timer or an on-duration timer for discontinuous reception.

Preferably, one of the at least one time value is associated with a time offset, wherein the wireless terminal receives a first number of DL channels and switches to the second state the time offset after receiving the last DL channel.

Preferably, one of the at least one time value is associated with a time offset, wherein the wireless terminal transmits a second number of UL channels and switches to the second state the time offset after transmitting the last UL channel.

Preferably, the at least one time value comprises at least one second time value associated with a second timer, wherein the second timer configured with the at least one second time value is configured to indicate the wireless terminal to perform at least one of:
switching to the active second state each time of an expiry of the second timer, or
monitoring a physical downlink control channel after the second timer expires Preferably, the second timer is a tracking area update timer.

Preferably, the at least one time value comprises a third time value associated with a third timer, wherein the third timer configured with the third time value is triggered by a start of at least one hybrid automatic repeat request, HARQ, process and the third timer is configured to indicate the wireless terminal to monitor a physical downlink control channel after the third timer expires.

Preferably, the wireless communication method further comprises: transmitting, to the wireless terminal, indication information, wherein the method further comprises at least one of:
performing, with the wireless terminal, an uplink synchronization within a fifth time value in the at least one time value after transmitting the indication information, or
performing, with the wireless terminal, a uplink transmission a fifth time value in the at least one time value after transmitting the indication information.

Preferably, the UL synchronization is at least one of: a global navigation satellite system reception, a tracking area calculation, or a frequency offset calculation.

Preferably, the wireless communication method further comprises: receiving, from the wireless terminal, position information of the wireless terminal.

The present disclosure relates to a wireless terminal. The wireless terminal comprises:
a processor configured to switch from a first state to a second state according to at least one time value.

Various embodiments may preferably implement the following feature:

Preferably, the processor is further configured to perform any of aforementioned wireless communication methods.

The present disclosure relates to a wireless network node. The wireless network node comprises:
a communication unit, configured to transmit, to a wireless terminal, at least one time value associated with switching the wireless terminal from a first state to a second state.

Various embodiments may preferably implement the following feature:

Preferably, the wireless network node further comprises a processor configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

### BRIEF DESCRIPTION OF THE DRAWINGS

The above and other aspects and their implementations are described in greater detail in the drawings, the descriptions, and the claims.

FIG. 1 shows a schematic diagram of a state transition of an NB -IoT UE.

FIG. 2 shows a schematic diagram of a state transition of an LTE UE.

FIG. 3 shows a schematic diagram of a wireless signal strength in a non-terrestrial network.

FIG. 4 shows a schematic diagram of a trigger of a temporary PSM timer according to an embodiment of the present disclosure.

FIG. 5 shows a schematic diagram of a wake-up timer according to an embodiment of the present disclosure.

FIG. 6 shows a schematic diagram of timers for possible coverages according to an embodiment of the present disclosure.

FIG. 7 shows a schematic diagram of a process according to an embodiment of the present disclosure.

FIG. 8 shows a schematic diagram of a sleep for a long return trip time according to an embodiment of the present disclosure.

FIG. 9 shows a schematic diagram of a postponed communication according to an embodiment of the present disclosure.

FIG. 10 shows a schematic diagram of a time offset before an uplink transmission according to an embodiment of the present disclosure.

FIG. 11 shows a flowchart of a method according to an embodiment of the present disclosure.

FIG. 12 shows a flowchart of a method according to an embodiment of the present disclosure.

FIG. 13 shows an example of a schematic diagram of a wireless terminal according to an embodiment of the present disclosure.

FIG. 14 shows an example of a schematic diagram of a wireless network node according to an embodiment of the present disclosure.

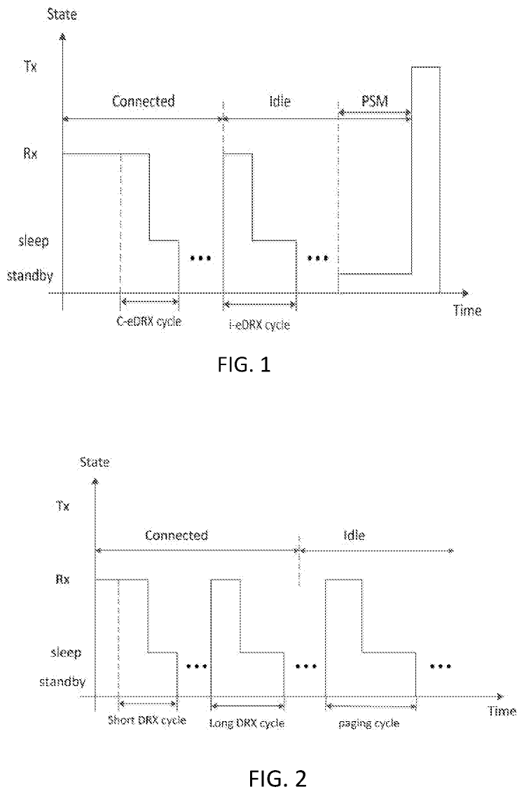

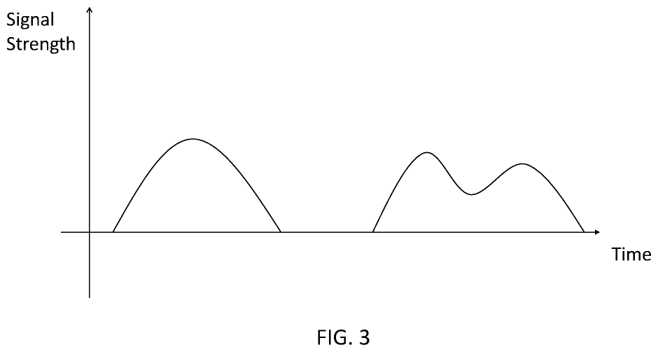

### DETAILED DESCRIPTION

In the present disclosure, a communication may refer to a transmission and/or a reception, and vice versa.

In the non-terrestrial network, there exists two kinds of beams, i.e., fixed beam and moving beam. The moving beam moves with the satellite/UAV (unmanned aerial vehicle). The beam direction of the moving beam is stationary with respect to the satellite/UAV. The fixed beam has a fixed coverage on the Earth when the satellite/UAV is not far away. With the movement of the satellite/UAV, the beam direction of the fixed beam is dynamically adapted to ensure that the coverage is approximately unchanged.

The discontinuous transmission technique (e.g. DRX, eDRX, PSM) is able to efficiently save power in wireless communications. In the LTE or the NB -IoT, the UE may periodically enter an inactive state (e.g. sleep state or standby state), which can be trigged by the DRX, eDRX or PSM technique. However, certain problems may appear when the discontinuous transmission technique is applied in the non-terrestrial network:
1. The signal coverage of the satellites/UAVs may be discontinuous. The DRX, eDRX or PSM mechanisms may require further enhancements to ensure that the UE in an on-duration can be served by the network.
2. The signal strength may have severe fluctuations because of a large velocity of the satellite/UAV. Thus, the UE in the on-duration may expect to be served by a large signal strength.
3. Because of a long return trip time (RTT), the UE and the base station (BS) may have no reception and/or transmission in certain periods, which should be supported by the enhanced discontinuous transmission.
4. At certain points in time, the UE may need to perform some particular functions such as GNSS positioning. The discontinuous transmission should be enhanced to support those kinds of operations.

In the present disclosure, a method is proposed for the discontinuous transmission. The characteristics of the proposed method include at least one of:
1. The BS indicates a time value to the UE, wherein a temporary PSM timer is started with the indicated time value.
2. The BS indicates one or more time values to the UE, to start one or more temporary tracking area update (TAU) timers.

3. The BS indicates a time value to the UE. The UE starts a timer with the indicated time value at a beginning of hybrid automatic repeat request (HARQ) processes and the UE may not monitor a physical downlink control channel (PDCCH) before the timer expires.

4. After receiving a PDCCH, the UE may indicate a time to the BS. The BS may transmit an uplink (UL) grant and/or a downlink (DL) assignment after the indicated time.

5. The BS may configure a time offset to the UE. When receiving a PDCCH which triggers UL transmission(s), the UE performs the triggered UL transmission after the time offset.

Case 1: Sleep for Discontinuation of Signal Coverage

In an embodiment, the BS indicates a time value to the UE. Based on the indicated time value, the UE starts its PSM timer and/or on-duration timer (DRX on-duration timer for DRX or eDRX). In this embodiment, the UE configures the indicated time value as a temporary value of the PSM timer and/or on-duration timer. After the PSM timer or the on-duration timer expires, the UE enters (e.g. switches to) an inactive state. Note that, the inactive state refers to the sleep state or the standby state in the present disclosure.

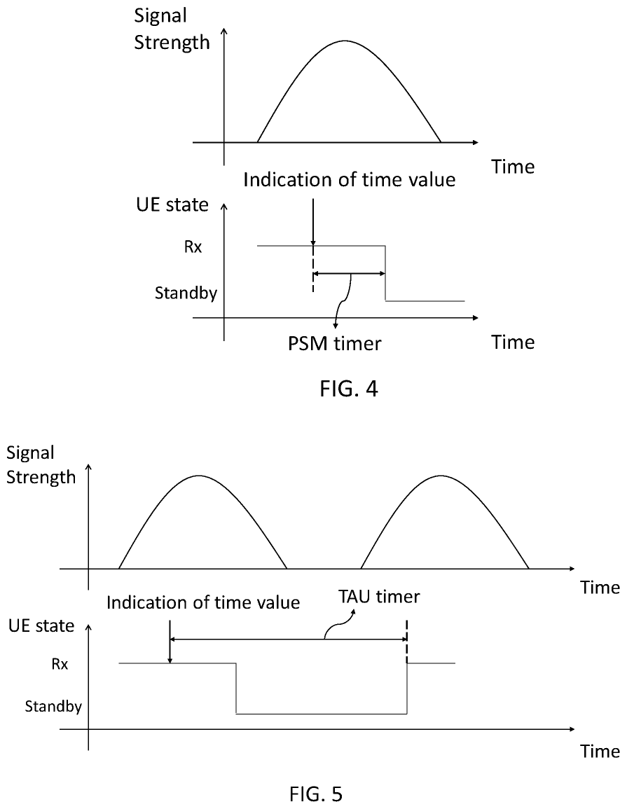

FIG. 4 shows a schematic diagram of triggering a temporary PSM timer according to an embodiment of the present disclosure. In this embodiment, the BS may determine that a signal strength of the UE may deteriorate after a certain time point and indicates a time value to the UE, to instructing the UE to enter the standby state when the signal strength deteriorates. The UE receives an indication of the time value from the BS and starts a PSM timer whose value is set as the indicated time value. When the PSM timer expires, the UE enters the standby state (e.g. deep-sleep state).

Case 2: Wake Up for Discontinuity of Signal Coverage

In an embodiment, the BS indicates a time value to the UE. The UE starts its TAU timer and configures the indicated time value as the temporary value of the TAU timer. As an alternative, the UE starts a new temporary timer having the indicated time value. Before the TAU timer or the new temporary timer expire, the UE stops monitoring a physical downlink control channel (PDCCH).

FIG. 5 shows a schematic diagram of an indicated timer of waking up according to an embodiment of the present disclosure. As shown in FIG. 5 the communications between the BS (e.g. satellite/UAV) and the UE may be discontinuous. In such conditions, the BS may indicate the UE a time value, e.g., to indicate a time point where the signal strength is appropriate (e.g. sufficient, good enough) for (efficient) communications. After receiving the indication of the time value, the UE triggers the TAU timer/temporary timer configured with the indicated time value. Before the TAU timer/temporary timer expires (i.e. before the expiry of the TAU timer/temporary timer), the UE stops monitoring the PDCCH. For example, the UE may enter the sleep state after receiving the indication of the time value and wakes up (i.e. enters an active state for performing reception (RX)) after the expiry of the TAU timer/temporary timer.

In an embodiment, the cases 1 and 2 may be combined. For example, the UE may enter the inactive state after the PSM timer in case 1 expires and until the TAU timer/temporary timer in case 2 expires. That is, the UE may wake up (e.g. enter an active state or a reception (RX) state) after the expiry of the TAU timer/temporary timer.

Case 3: Wake Up for Discontinuity of Signal Coverage with Possible UE Movement

In an embodiment, the UE may move while communicating with the BS (e.g. satellite/UAV). In some embodiments, after being in the deep sleep state of the PSM or off duration of the DRX (e.g. eDRX), the UE may not remain in the coverage of the BS. Under such conditions, the BS may indicate one or more time values to the UE, e.g., to indicate one or more time points of the UE (possibly) being in the coverage of the BS. The UE starts its TAU timer and configures one of the time values (e.g. the minimum time value in the indicated time values) as the temporary candidate value of the TAU timer. The UE may try to access the network when the TAU timer expires. If detecting no downlink (DL) signal (e.g. PDCCH), the UE enters the sleep state or the standby state and resets the TAU timer to the next indicated value (e.g. the second minimum time value), and so on. Note that, the TAU timer may be replaced by a temporary timer (see, e.g., Case 2). That is, the update for tracing area may be unnecessary when the UE wakes up (i.e. when the temporary timer expires).

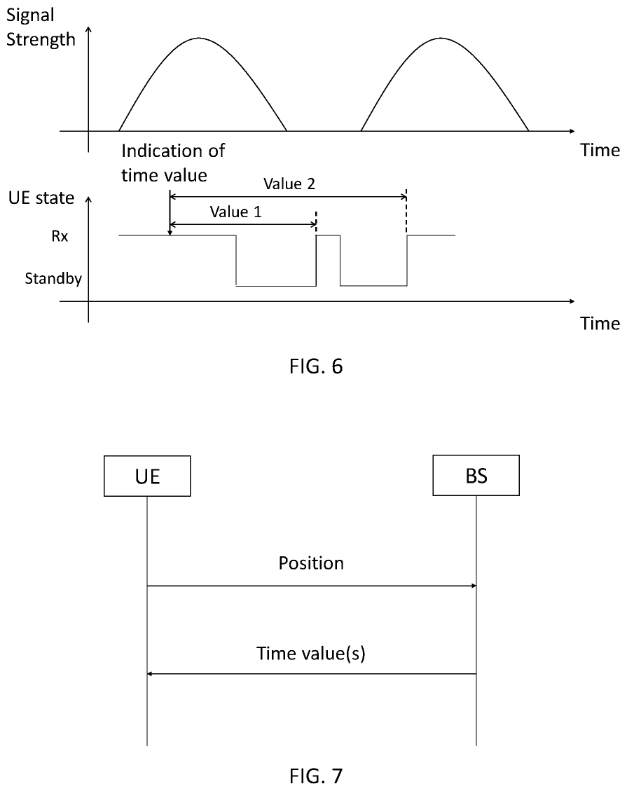

FIG. 6 shows a schematic diagram of an indication of TAU timer values for possible coverage according to an embodiment of the present disclosure. In this embodiment, the BS indicates two time values (i.e. value 1 and value 2) for the TAU timer to the UE. After receiving the indication, the UE configures the TAU time with the value 1 and enters the standby state. When the TAU time configured with the value 1 expires, the UE wakes up (i.e. enters the RX state) and tries to receive (e.g. detect or monitor) DL signal from the BS. In this embodiment, the UE does not receive DL signal after the TAU time with the value 1 expires and enters the standby state again. In addition, the UE configures the TAU timer configured with the value 2. Note that the TAU timer is started when (or after) receiving the indication. When the TAU timer configured with the value 2 expires, the UE wakes up and tries to receive (e.g. detect or monitor) DL signal from the BS. In FIG. 6, the UE is in the coverage of the BS when the TAU timer configured with the value 2 expires and receives DL signal (e.g. PDCCH) from the BS.

Case 4: Indication of Position

In this embodiment, the UE reports its position to the BS. Accordingly, the BS is able to estimate the time of the UE entering sleep and/or the time of the UE waking up, e.g., based on the varied coverage (e.g. changed signal strength of the signal from the BS to the US). The estimated time value may be indicated to the UE as those in the cases 1, 2 and 3.

Case 5: Sleep for Long RTT

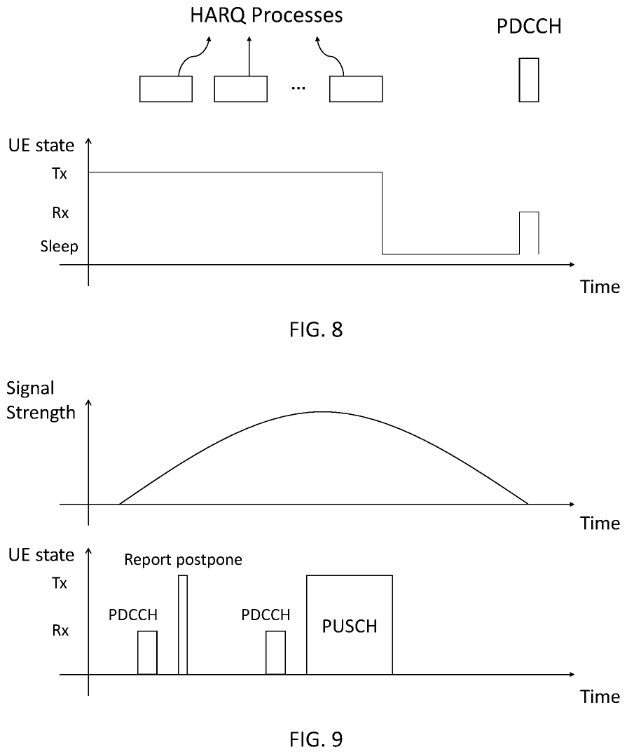

If the RTT is longer than a time length of all hybrid automatic repeat request (HARQ) processes, the UE may enter the sleep state after finishing the HARQ processes. In such a condition, the BS indicates a time value to the UE, e.g., to indicate the time the UE should wake up for receiving corresponding DL signal (e.g. PDCCH). Based on the indicated time value, the UE configures a timer with the indicated time value, wherein the timer starts (e.g. is triggered) at the beginning of the HARQ processes. After finishing the HARQ processes, the UE enters the (DRX/eDRX) sleep state. Before the expiry of the timer, the UE does not monitor the corresponding DL signal (i.e. remains in the sleep state or does not wake up) (see. FIG. 8).

Case 6: Postponement of Communication

In an embodiment, the UE may postpone UL and/or DL communication(s) after receiving the PDCCH in a paging procedure, so as to perform the UL and/or DL communication(s) more efficiently. For example, the postponed UL and/or DL communication(s) may be served by a better link quality and/or link budget. Thus, when the BS tries to wake up the UE from the sleep state (e.g. transmits the PDCCH to the UE), the BS may not expect that the UL and/or DL transmission(s) is performed immediately after the UE wakes up. In an embodiment, after waking up and receiving the PDCCH (i.e. paging), the UE may indicate a postpone time to the BS. The BS postpones the corresponding communications based on the indicated postpone time. For example, the BS may transmit a UL grant and/or a DL assignment the indicated postpone time after receiving the indication.

In an embodiment, the postpone time may be indicated from the BS to the UE. For example, after waking up and receiving the PDCCH (i.e. paging), the UE may indicate (e.g. report) its position to the BS. The BS accordingly determines the postpone time and indicates the postpone time to the UE. The UE may enter the sleep state and wake up the indicated postpone time after receiving the indication. Next, the BS may transmit a UL grant and/or a DL assignment the determined postpone time after transmitting the indication.

FIG. 9 shows a schematic diagram of the postponement for saving the link budget according to an embodiment of the present disclosure. In FIG. 9, the UE receives a first PDCCH from the BS. In this embodiment, the UE may determine that the communications may consume more power and/or resources because of current link quality (e.g. signal strength). Under such conditions, the UE reports (e.g. transmits, indicates) the postpone time to the BS. After the postpone time, the BS transmits the PDCCH again and the UE performs corresponding UL transmission(s) (e.g. physical UL shared channel (PUSCH)).

Case 7: Time Offset Before UL Transmission

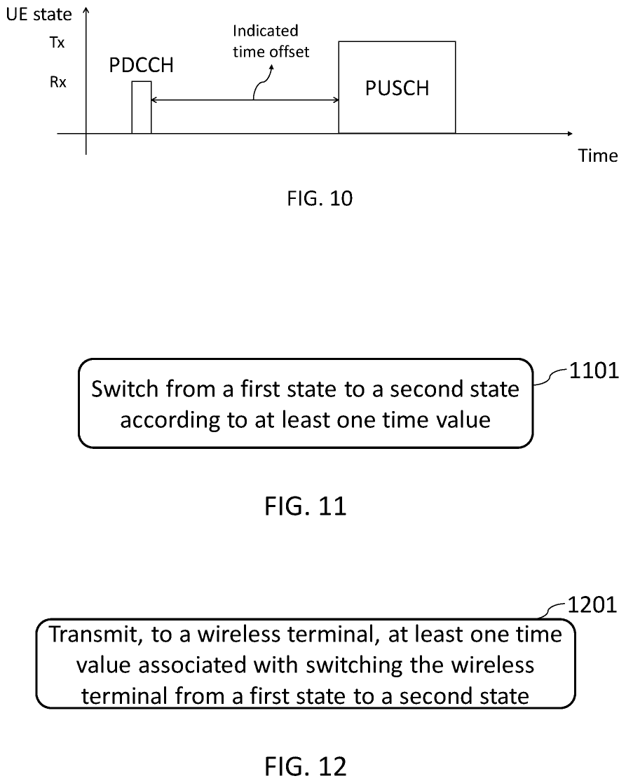

In an embodiment, the BS indicates a time offset to the UE. After receiving the PDCCH which triggers UL transmission(s) (e.g. PUSCH transmission), the UE performs the triggered UL transmission(s) after the time offset (see FIG. 10). Note that the UE may enter the sleep state or the deep-sleep state (i.e. standby state) in the period from receiving the PDCCH to transmitting the PUSCH.

In the present disclosure, a method is proposed to reduce the power consumption of the UE. The characteristics of proposed method include at least one of:
1. The BS indicates a time value to UE, to start a temporary PSM timer configured with the time value.
2. The BS indicates one or more time values to UE to start one or more temporary timers/TAU timers.
3. The BS indicates a time value to UE. The UE starts a timer with the configured value at the beginning of the HARQ processes, and does not monitor the corresponding PDCCH before the expiry of the timer.
4. After receiving the PDCCH, the UE may indicate a time value to the BS. The BS transmits the UL grant or DL assignment after the indicated time value.
5. The BS may configure a time offset to the UE. After receiving the PDCCH which triggers UL transmission, the UE may enter the sleep state or deep sleep state and perform the corresponding UL transmission after the time offset.

FIG. 11 shows a flowchart of a method according to an embodiment of the present disclosure. The method may be used in a wireless terminal (e.g. UE) and comprises the following step:

Step 1101: Switch from a first state to a second state according to at least one time value.

In this embodiment, the wireless terminal switches from a first state to a second state according to at least one time value. Note that, each of the at least one time value may be predefined or configured by (e.g. received from) a wireless network node (e.g. BS).

In an embodiment, the first state is one of an active state or an inactive state and the second state is another one of the active state and the inactive state. For example, the active state may be an RRC connected state or a state of (wireless terminal) performing (continuous) communications according to a scheduling (e.g. based on received DCI).

In addition, the inactive state is a sleep state or a standby state. More specifically, the inactive state may be a sleep state or an eDRX off state. In the inactive state, the UE does not transmit or receive any information from the wireless network node. As an alternative, the inactive state may refer to an eDRX or PSM mode cycle, which is only valid within certain time. The valid time may also be one of the at least one time value.

In an embodiment, the wireless terminal may start a first timer configured with a first time value in the at least one time value, e.g. when receiving the indication of the first time value. When the first timer expires, the wireless terminal switches to the second state. In an embodiment, the first timer is the PSM timer or on-duration timer for DRX or eDRX.

In an embodiment, the wireless network may enter the second state (e.g. inactive state) once the number of transmissions/receptions exceeds the maximal number. For example, the wireless terminal may receive a first number of DL channels (e.g. PDCCH, PDSCH, NPDSCH) and switch to the second state a time offset after receiving the last DL channel. The time offset may be one of the at least one time value which is predefined or configured by the wireless network node.

For example, after receiving X DCI scheduled PDSCHs (e.g., each DCI schedules one PDSCH or NPDSCH), the wireless terminal enters the second state (e.g. inactive state), e.g., because the large RTT in the non-terrestrial network is not fulfilled by the DL transmission. In an embodiment, the wireless terminal may enter the second state after transmitting the acknowledge/non-acknowledge (ACK/NACK) in response to the X^{th} DCI scheduled PDSCHs or all X PDSCHs (NPDSCHs).

As an alternative or in addition, the wireless terminal may transmit a second number of UL channels (e.g. PUCCH, PUSCH, NPUSCH) and switch to the second state a time offset after transmitting the last UL channel. The time offset may be one of the at least one time value which is predefined or configured by the wireless network node.

Note that, the term “first number” or “second number” may refer to: the maximal supported HARQ processes number or a configured value from the wireless network node (e.g. BS).

In addition, the inactive state can be either the sleep state or standby state. As an alternative, the inactive state refers to a second configured (e.g., short) eDRX state or PSM state.

Furthermore, after another time offset, the wireless terminal may perform:
1. If the second state is the sleep state or standby state, the UE may enter the active state for monitoring the PDCCH.
2. If the second state is the second configured (e.g., short) eDRX state or PSM state, the wireless terminal may enter a first configured (e.g. long) eDRX or PSM mode.

In an embodiment, a second timer configured with at least one second time value in the at least one time value is started, e.g., when receiving the at least one second time value. The wireless terminal may switch to the second state each time of an expiry of the second timer. As an alternative or in addition, the wireless terminal may (switch to the second state and) monitor the PDCCH after the second timer expires (see, e.g., cases 2 and 3).

In an embodiment, the second timer is the TAU timer.

In an embodiment, a third timer is configured with a third time value in the at least one time value. The third timer is triggered by a start of at least one HARQ process. The wireless terminal may switch to the second state after finishing the at least one HARQ process and/or monitor the PDCCH after the third timer expires. Note that, finishing the at least one HARQ process may refer to completing reception(s) of PDSCHs/NPDSCHs scheduled with the at least one HARQ process.

In an embodiment, the wireless terminal may receive indication information (e.g. paging message, paging signal, wake-up signal (WUS) or scheduling information for either DL or UL) from the wireless network node. In this embodiment, the wireless terminal may perform a UL synchronization (e.g. with the wireless network node) within a fifth time value in the at least one time value after receiving the indication information. As an alternative or in addition, the wireless terminal may perform a UL transmission (e.g. with the wireless network node) the fifth time value after receiving the indication information.

Note that, once the wireless terminal is waked up by paging and/or from the PSM, there is a timer (e.g. period) before transmission/reception. For the NTN, this timer may extended by the fifth time value or an additional timer (e.g. configured with the fifth time value) is introduced to enable corresponding behavior for the UL synchronization and/or UL transmission.

In an embodiment, the UL synchronization is at least one of: a global navigation satellite system (GNSS) reception, a tracking area (TA) calculation, or a frequency offset calculation.

In an embodiment, the fifth time value is an additional offset configured by the wireless network node.

In an embodiment, the wireless terminal may transmit (e.g. report) its position (information) to the wireless network node.

FIG. 12 shows a flowchart of a method according to an embodiment of the present disclosure. The method may be used in a wireless network node (e.g. BS) and comprises the following step:

Step 1201: Transmit, to a wireless terminal, at least one time value associated with switching the wireless terminal from a first state to a second state.

In an embodiment, the first state is one of an active state or an inactive state and the second state is another one of the active state or the inactive state.

In an embodiment, wherein the active state is the RRC connected state or a state of performing communications according to a scheduling.

In an embodiment, the inactive state is a sleep state or a standby state.

In an embodiment, the at least one time value comprises a first time value associated with a first timer. The first timer configured with the first time value is configured to indicate the wireless terminal to switch to the second state after an expiry of the first timer.

In an embodiment, the first timer is a PSM timer or an on-duration timer for DRX.

In an embodiment, one of the at least one time value is associated with a time offset. The wireless terminal receives a first number of DL channels and switches to the second state the time offset after receiving the last DL channel.

In an embodiment, one of the at least one time value is associated with a time offset. The wireless terminal transmits a second number of UL channels and switches to the second state this time offset after transmitting the last UL channel.

In an embodiment, the at least one time value comprises at least one second time value associated with a second timer. The second timer configured with the at least one second time value is configured to indicate the wireless terminal to perform at least one of:
switching to the second state each time of an expiry of the second timer, or
monitoring a PDCCH after the second timer expires.

In an embodiment, the second timer is the TAU timer.

In an embodiment, the at least one time value comprises a third time value associated with a third timer. The third timer configured with the third time value is triggered by a start of at least one HARQ process. The third timer is configured to indicate the wireless terminal to monitor a PDCCH after the third timer expires.

In an embodiment, the wireless network node may transmit indication information (e.g. paging signal, paging message, WUS, scheduling information for either DL or UL). The wireless network may perform, with the wireless terminal, at least one of:
a UL synchronization within a fifth time value in the at least one time value after transmitting the indication information,
a UL transmission (e.g. triggered by the indication information) a fifth time value in the at least one time value after transmitting the indication information.

In an embodiment, the UL synchronization is at least one of: a GNSS reception, a TA calculation, or a frequency offset calculation.

In an embodiment, the wireless network node may receive position (information) of the wireless terminal from the wireless terminal. The wireless network node may determine the at least one time value based on the received position (information).

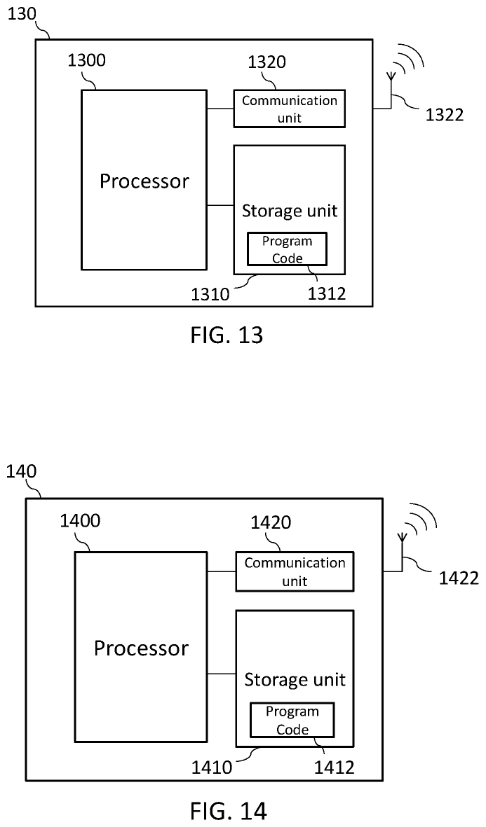

FIG. 13 relates to a schematic diagram of a wireless terminal 130 according to an embodiment of the present disclosure. The wireless terminal 130 may be a user equipment (UE), a mobile phone, a laptop, a tablet computer, an electronic book or a portable computer system and is not limited herein. The wireless terminal 130 may include a processor 1300 such as a microprocessor or Application Specific Integrated Circuit (ASIC), a storage unit 1310 and a communication unit 1320. The storage unit 1310 may be any data storage device that stores a program code 1312, which is accessed and executed by the processor 1300. Embodiments of the storage unit 1312 include but are not limited to a subscriber identity module (SIM), read-only memory (ROM), flash memory, random-access memory (RAM), hard-disk, and optical data storage device. The communication unit 1320 may a transceiver and is used to transmit and receive signals (e.g. messages or packets) according to processing results of the processor 1300. In an embodiment, the communication unit 1320 transmits and receives the signals via at least one antenna 1322 shown in FIG. 13.

In an embodiment, the storage unit 1310 and the program code 1312 may be omitted and the processor 1300 may include a storage unit with stored program code.

The processor 1300 may implement any one of the steps in exemplified embodiments on the wireless terminal 130, e.g., by executing the program code 1312.

The communication unit 1320 may be a transceiver. The communication unit 1320 may as an alternative or in addition be combining a transmitting unit and a receiving unit configured to transmit and to receive, respectively, signals to and from a wireless network node (e.g. a base station).

FIG. 14 relates to a schematic diagram of a wireless network node 140 according to an embodiment of the present disclosure. The wireless network node 140 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB -CU), a gNB distributed unit (gNB -DU) a data network, a core network or a Radio Network Controller (RNC), and is not limited herein. In addition, the wireless network node 140 may comprise (perform) at least one network function such as an access and mobility management function (AMF), a session management function (SMF), a user place function (UPF), a policy control function (PCF), an application function (AF), etc. The wireless network node 140 may include a processor 1400 such as a microprocessor or ASIC, a storage unit 1410 and a communication unit 1420. The storage unit 1410 may be any data storage device that stores a program code 1412, which is accessed and executed by the processor 1400. Examples of the storage unit 1412 include but are not limited to a SIM, ROM, flash memory, RAM, hard-disk, and optical data storage device. The communication unit 1420 may be a transceiver and is used to transmit and receive signals (e.g. messages or packets) according to processing results of the processor 1400. In an example, the communication unit 1420 transmits and receives the signals via at least one antenna 1422 shown in FIG. 14.

In an embodiment, the storage unit 1410 and the program code 1412 may be omitted. The processor 1400 may include a storage unit with stored program code.

The processor 1400 may implement any steps described in exemplified embodiments on the wireless network node 140, e.g., via executing the program code 1412.

The communication unit 1420 may be a transceiver. The communication unit 1420 may as an alternative or in addition be combining a transmitting unit and a receiving unit configured to transmit and to receive, respectively, signals to and from a wireless terminal (e.g. a user equipment or another wireless network node).

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method for use in a wireless terminal, the method comprising:
switching from a first state to a second state according to at least one time value.

2. The wireless communication method of claim 1, wherein the first state is one of an active state or an inactive state and the second state is another one of the active state or the inactive state
wherein the active state is a radio resource control connected state or a state of performing communications according to a scheduling, wherein the inactive state is a sleep state or a standby state.

3-4. (canceled)

5. The wireless communication method of claim 1, wherein a first timer configured with a first time value in the at least one time value is started, and
wherein switching from the first state to the second state according to at least one time value comprises:
switching to the second state when the first timer expires
wherein the first timer is a power saving mode timer or an on-duration timer for discontinuous reception.

6. (canceled)

7. The wireless communication method of claim 1, wherein switching from the first state to the second state according to at least one time value comprises:
receiving a first number of DL channels, and
switching to the second state a time offset after receiving the last DL channel, wherein the time offset is one of the at least one time value.

8. The wireless communication method of claim 1, wherein switching from the first state to the second state according to at least one time value comprises:
transmitting a second number of UL channels, and
switching to the second state a time offset after transmitting the last UL channel, wherein the time offset is one of the at least one time value.

9. The wireless communication method of claim 1, wherein a second timer configured with at least one second time value in the at least one time value is started, wherein switching from the first state to the second state according to at least one time value comprises at least one of:
switching to the second state each time of an expiry of the second timer, or
monitoring a physical downlink control channel after the second timer expires
wherein the second timer is a tracking area update timer.

10. (canceled)

11. The wireless communication method of claim 10, wherein a third timer is configured with a third time value in the at least one time value,
wherein the third timer is triggered by a start of at least one hybrid automatic repeat request, HARQ, process,
wherein switching from the first state to the second state according to at least one time value comprises at least one of:
switching to the second state after finishing the at least one HARQ process, or
monitoring a physical downlink control channel after the third timer expires.

12. The wireless communication method of claim 1, further comprising:
receiving, from a wireless network node, indication information,
wherein switching from the first state to the second state according to at least one time value comprises at least one of:
performing, with the wireless network node, a UL synchronization within a fifth time value in the at least one time value after receiving the indication information, or
performing, with the wireless network node, a UL transmission a fifth time value in the at least one time value after receiving the indication information
wherein the UL synchronization is at least one of: a global navigation satellite system reception, a tracking area calculation, or a frequency offset calculation,
wherein the fifth time value is an additional offset configured by a wireless network node.

13-14. (canceled)

15. The wireless communication method of claim 1, further comprising:
transmitting, to a wireless network node, position information of the wireless terminal.

16. A wireless communication method for use in a wireless network node, the method comprising:
transmitting, to a wireless terminal, at least one time value associated with switching the wireless terminal from a first state to a second state.

17. The wireless communication method of claim 16, wherein the first state is one of an active state or an inactive state and the second state is another one of the active state or the inactive state
wherein the active state is a radio resource control connected state or a state of performing communications according to a scheduling,
wherein the inactive state is a sleep state or a standby state.

18-19. (canceled)

20. The wireless communication method of claim 16, wherein the at least one time value comprises a first time value associated with a first timer,
wherein the first timer configured with the first time value is configured to indicate the wireless terminal to switch to the second state after an expiry of the first timer
wherein the first timer is a power saving mode timer or an on-duration timer for discontinuous reception.

21. (canceled)

22. The wireless communication method of claim 16, wherein one of the at least one time value is associated with a time offset, wherein:
the wireless terminal receives a first number of DL channels and switches to the second state the time offset after receiving the last DL channel.

23. The wireless communication method of claim 16, wherein one of the at least one time value is associated with a time offset,
wherein the wireless terminal transmits a second number of UL channels and switches to the second state the time offset after transmitting the last UL channel.

24. The wireless communication method of claim 16, wherein the at least one time value comprises at least one second time value associated with a second timer,
wherein the second timer configured with the at least one second time value is configured to indicate the wireless terminal to perform at least one of:
switching to the second state each time of an expiry of the second timer, or
monitoring a physical downlink control channel after the second timer expires,
wherein the second timer is a tracking area update timer.

25. (canceled)

26. The wireless communication method of claim 16, wherein the at least one time value comprises a third time value associated with a third timer,
wherein the third timer configured with the third time value is triggered by a start of at least one hybrid automatic repeat request, HARQ, process,
wherein the third timer is configured to indicate the wireless terminal to monitor a physical downlink control channel after the third timer expires.

27. The wireless communication method of claim 16, further comprising:
transmitting, to the wireless terminal, indication information, and
wherein the method further comprises at least one of:
performing, with the wireless terminal, an uplink synchronization within a fifth time value in the at least one time value after transmitting the indication information, or
performing, with the wireless terminal, a uplink transmission a fifth time value in the at least one time value after transmitting the indication information,.
wherein the UL synchronization is at least one of: a global navigation satellite system reception, a tracking area calculation, or a frequency offset calculation.

28. (canceled)

29. The wireless communication method of claim 16, further comprising:
receiving, from the wireless terminal, position information of the wireless terminal.

30. A wireless terminal, comprising:
a processor, configured to switch from a first state to a second state according to at least one time value.

31. (canceled)

32. A wireless network node, comprising:
a communication unit, configured to transmit, to a wireless terminal, at least one time value associated with switching the wireless terminal from a first state to a second state.

33-34. (canceled)
